(19) United States
(12) Patent Application Publication
(10) Pub. No.: US 2009/0079307 A1
(43) Pub. Date: Mar. 26, 2009

(54) Cabinet or Shelving Furniture

(75) Inventor: Reinhard Weber, Minden (DE)

Correspondence Address: LERNER GREENBERG STEMER LLP, P O BOX 2480, HOLLYWOOD, FL, 33022-2480, US

(73) Assignee: VS Vereinigte Spezialmobelfabriken GmBH & Co. KG, Tauberbischofsheim (DE)

(21) Appl. No.: 12/234,907

(22) Filed: Sep. 22, 2008

(30) Foreign Application Priority Data
Sep. 20, 2007 (DE) DE102007044875.0

(51) Int. Cl. E06B 5/20; E06B 5/00

(52) U.S. Cl. 312/294

(57) ABSTRACT

A piece of furniture such as a cabinet or shelving has at least one panel-shaped door or wall element that has a stable support sheet, which is provided on its inner side, and a functional element, which is provided on its outer side and which has substantially the same size and shape as the support sheet and is connected to the support sheet. Fittings of the door or wall element are mounted on the support sheet.

### CROSS-REFERENCE TO RELATED APPLICATIONS

This application claims the priority, under 35 U.S.C. §119, of German application DE 10 2007 044 875.0, filed Sep. 20, 2007; the prior application is herewith incorporated by reference in its entirety.

### BACKGROUND OF THE INVENTION

1. Field of the invention

The present invention relates to cabinet or shelving furniture having at least one panel-shaped door or wall element.

For items of furniture such as cabinets, shelving units and tables, there is increasingly a desire that in addition to their main function of storing objects or providing a work surface they should also fulfill other, additional tasks.

An additional task of this kind is for example the reduction of noise in rooms, for which purpose the side walls and doors of items of furniture may be made from sound-absorbent panels. Sound-absorbent panels of this kind, of the type also used in side walls and doors of items of furniture, are known for example from published, European application EP 1 357 237 A2, published, European application EP 0 745 738 A1 and German patent DE 102 48 072 B4. The sound-absorbent panels described in these documents in each case contain a plurality of grooved and/or perforated wooden panels that are connected to one another over their large surfaces.

### SUMMARY OF THE INVENTION

It is accordingly an object of the invention to provide a cabinet or shelving furniture which overcome the above-mentioned disadvantages of the prior art methods and devices of this general type, which has at least one panel-shaped door or wall element that on the one hand can fulfill at least one additional task but at the same time has a high level of dimensional stability.

The object is achieved by a cabinet or shelving that is characterized in that it has at least one panel-shaped door or wall element that contains a stable support sheet, which is provided on its inner side, and a functional element, which is provided on its outer side and which conventionally has substantially the same size and shape as the support sheet and is connected to the support sheet. A fitting of the door or wall element is mounted on the support sheet.

The desired additional task of the panel-shaped door or wall element of the item of furniture is fulfilled as required by an appropriate functional element. Because the functional element is connected to a support sheet on the inside, a high level of dimensional stability of the door or wall element is ensured, regardless of the material of the functional element and any thinning of the material which may be present. In addition, fittings of the component (hinges, roller devices, locks, devices for connecting to further components of the item of furniture, handle elements and the like) are mounted on the stable support sheet. This has the effect that the forces occurring at the fittings are introduced into the stable support sheet at the location where they occur, which further increases the dimensional stability of the panel-shaped door or wall element.

In a preferred embodiment of the invention, at least one edge or all the edges of the support sheet are bent around in the direction of the functional element. In this way, the dimensional stability of the support sheet and hence also that of the entire door or wall element are increased.

The fitting of the door or wall element may optionally be secured to the support sheet or integrated into the support sheet itself.

In an embodiment of the invention, the support sheet takes the form of a perforated sheet. This variant is advantageous in respect of the weight of the door or wall element and in conjunction with a sound-absorbent panel as the functional element.

Depending on the type of functional element, an intermediate layer (for example a connecting layer, a damping layer, an acoustic fleece, etc.) may also be disposed between the support sheet and the functional element.

The functional element is optionally a one-piece functional element or may also have a plurality of similar or different functional elements.

Conceivable functional elements within the scope of the present invention are, for example, decorative elements, sound-absorbent elements, boards for writing on, pin boards, magnetic boards, light elements and combinations thereof.

In a particular embodiment of the invention, the support sheet is a perforated sheet, an (acoustic) fleece being disposed on the side thereof that faces the functional element, and the functional element also has a perforated sheet, an (acoustic) fleece being arranged on the side thereof that faces the support sheet, with the cavity between the support sheet and the functional element optionally being filled with a material having sound-absorption properties. In this case, the support sheet also forms a component of the sound-absorbent element.

Other features which are considered as characteristic for the invention are set forth in the appended claims.

Although the invention is illustrated and described herein as embodied in a cabinet or shelving furniture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, front view of a cabinet having sliding doors according to the invention;

FIG. 2 is a diagrammatic, partial sectional view of a basic structure of a panel-shaped door or wall element according to the invention, taken along the line II-II shown in FIG. 1;

FIG. 3 is a diagrammatic, partial sectional view of a support sheet having mounted thereon a fitting, taken along the section line II-II shown in FIG. 1;

FIG. 4 is a diagrammatic, partial sectional view of the support sheet having mounted thereon a fitting, taken along the section line II-II shown in FIG. 1;

FIG. 5 is a diagrammatic, partial sectional view of the panel-shaped door or wall element according to a first exemplary embodiment of the invention;

FIG. 6 is a diagrammatic, partial sectional view of the panel-shaped door or wall element according to a second exemplary embodiment of the present invention;

FIG. 7 is a diagrammatic, partial sectional view of the panel-shaped door or wall element according to a third exemplary embodiment of the present invention;

FIG. 8 is a diagrammatic, partial sectional view of the panel-shaped door or wall element according to a fourth exemplary embodiment of the present invention;

FIG. 9 is a diagrammatic, partial sectional view of the panel-shaped door or wall element according to a fifth exemplary embodiment of the present invention; and

FIG. 10 is a diagrammatic, sectional view of a variant on the basic structure of the door or wall element of the invention from FIG. 2.

### DETAILED DESCRIPTION OF THE INVENTION

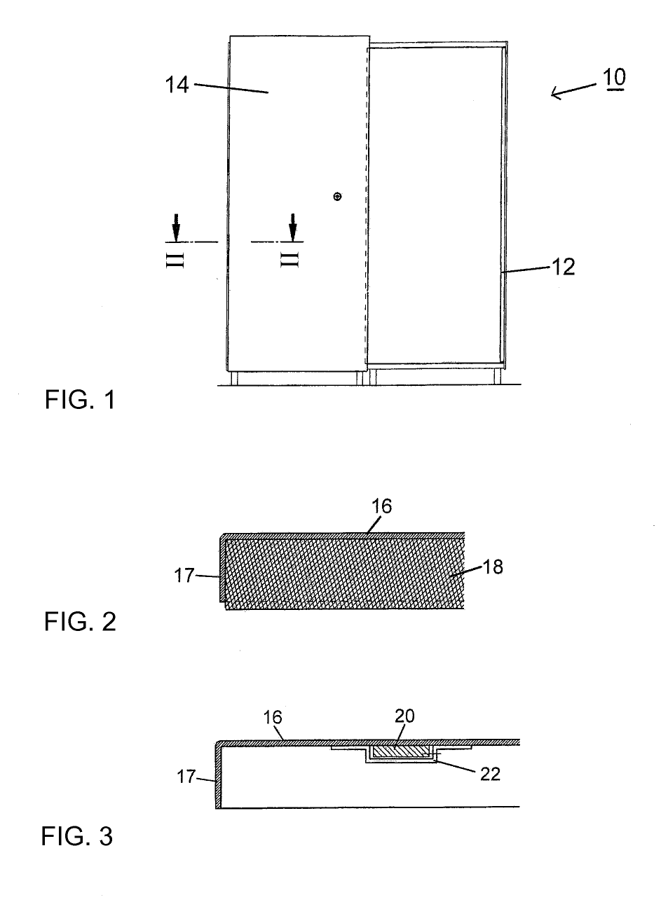

Referring now to the figures of the drawing in detail and first, particularly, to FIG. 1 thereof, there is shown a piece of furniture, namely a cabinet 10, in which the present invention may be used. The cabinet 10 substantially contains a cabinet carcass 12, which is open at a front side, and at least one cabinet door 14 for closing a front opening of the cabinet carcass, which in this case takes the form of a sliding door. It goes without saying that the present invention may equally be applied to other items of furniture, such as shelving units and the like, and to items of furniture having pivotal doors, drop-down leaves and the like.

The present invention will be described below in detail with reference to a cabinet door as a panel-shaped door or wall element. However, the door or wall element of the cabinet or shelving furniture may, in an analogous way, also be for example a side wall of a cabinet or shelving unit, a rear wall of a cabinet or shelving unit and the like. The present invention may be applied particularly advantageously in the case of a cabinet door, since in this case, because of its construction as a moving component, in general higher loads occur. For the sake of simplicity, the door or wall element is mostly only called a cabinet door in the description below.

With reference to FIGS. 2 to 4, the basic structure of the panel-shaped door or wall element of the invention will first of all be described in detail.

As generally illustrated in FIG. 2, the cabinet door 14 is substantially constructed from a support sheet 16 on the inside and a functional element 18 on the outside, which are fixedly connected to one another. The connection between the support sheet 16 and the functional element 18, which is preferably over their large surfaces, is made for example by gluing, clamping, screwing, a gripper-type closure or the like. The functional element 18 preferably has substantially the same size and the same shape as the support sheet 16, such that they can form a stable integral unit by way of being coupled at their large surface. The stable support sheet 16 may optionally take the form of a solid sheet or a perforated sheet.

The support sheet 16 is bent preferably around all its edges 17 in the direction of the functional element 18. As a result of the bending around of the edges, the dimensional stability of the support sheet 16 and thus of the entire cabinet door 14 is markedly increased. Within the scope of the present invention, not all the edges 17 of the support sheet 16 need be bent around; for example, it is also possible for only two opposing edges or only one edge to be bent around. As well as increasing the stability of the support sheet 16, the bent-around edges also form a protection of the edge surfaces of the functional element 18.

Where required, it is also possible to dispense with the bent-around edges 17 of the support sheet 16 completely, that is to say to provide the support sheet 16 as a substantially flat component. In this case, the functional element 18 that is connected to the flat support sheet 16 should have sufficient intrinsic stability.

The side of the functional element 18 that faces the viewer may optionally end flush with the bent-around edges 17 of the support sheet 16, project somewhat beyond these, as illustrated in FIG. 2, or be recessed somewhat therefrom.

The support sheet 16 and the functional element 18 form an integral unit, namely the cabinet door 14, which may be assembled to the cabinet carcass 12 as one component. Depending on the application case or the intended use of the cabinet 10, however, the functional element 18 may take different forms or have different functions. Thus, for example, the functional element 18 may be a decorative element, a sound-absorbent element, a board for writing on, a pin board, a magnetic board, a light element or a combination of such elements, as will be described in more detail below.

Fittings that are provided on the cabinet door 14, such as hinges in the case of pivotal or swing doors, roller devices in the case of sliding doors, locks, door handles, etc., are mounted on the support sheet 16 such that the forces that occur when the cabinet door 14 is moved in relation to the cabinet carcass 12 are introduced into the support sheet 16 directly at the location where they occur. The fittings can in this case optionally be secured to the support sheet 16 or (if the support sheet is of sufficiently thick material) be integrated into the support sheet 16 itself. Within the scope of the invention, the term “fittings” is understood to mean all measures for connecting to other components of the item of furniture (for example between two side walls, between the side wall and the base). Some of the fittings, such as the door handles, may, depending on the type of functional element 18, optionally also be secured to the latter.

FIG. 3 shows by way of example the mounting of a locking rod (fitting) 20 that is guided in a corresponding rod guide 22 that is in turn secured to the support sheet 16 (glued, welded, screwed, etc.). The locking rod 20 may in this case extend hidden on the side of the support sheet 16 that faces the functional element 18 (which is not illustrated in FIG. 3), or be arranged on the side of the support sheet 16 that faces the cabinet carcass 12.

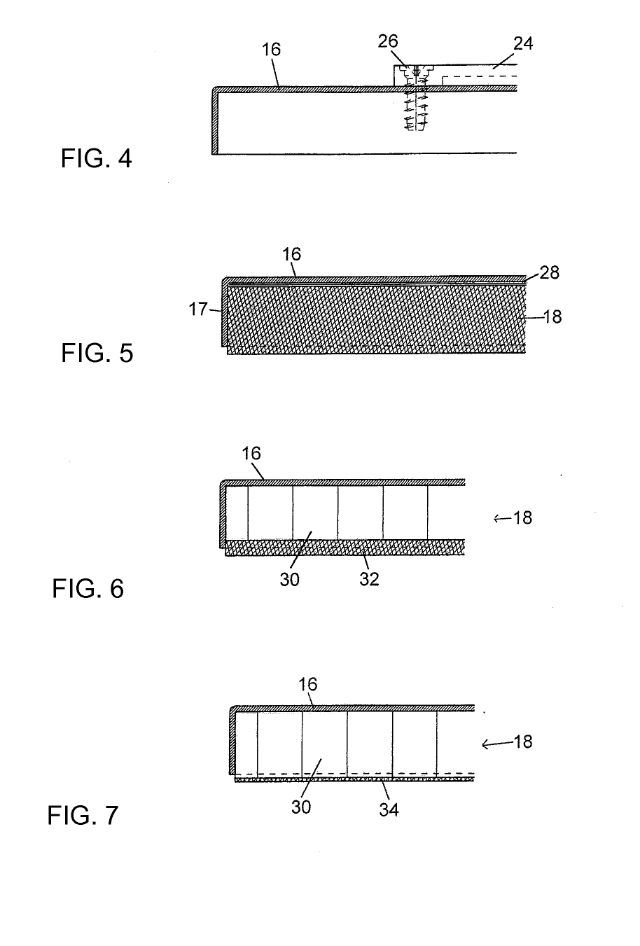

FIG. 4 shows the mounting of a hinge 24, as a further example of a fitting, by a screw connection 26 to the support sheet 16, in which the hinge 24 must of course be arranged on the side of the support sheet 16 that faces the cabinet carcass 12.

Further types of fittings and their securing to the support sheet 16 will be apparent to those skilled in the art.

If the cabinet door 14 were formed by the functional element 18 itself, the cabinet door would have only limited dimensional stability, determined by the material and/or the construction of the functional element, in particular in the case of large components. For example, the sound-absorbent elements that were mentioned at the outset are frequently formed by a plurality of grooved and/or perforated panels. The fact that the material is made thinner by the grooves and perforations, and the multi-layered nature (in particular with an asymmetric construction and with fluctuations in humidity and temperature), result in an undesirable instability of the component, which has an even greater effect on the long-term functionality of the component in the case of moving components such as cabinet doors. In addition, in this conventional case the fittings of the cabinet door are mounted on the functional element, which results in further weakening and hence instability of the component.

In contrast thereto, according to the present invention a very stable door or wall element 14 for items of furniture can be provided by connecting the functional element 18 to the support sheet 16 and by mounting the fittings on the stable support sheet 16. Moreover, the inventive construction of the component forms the basis for a very variable structure of the door or wall element and the item of furniture, since with the same basic structure, depending on the application case and intended use, different functional elements may be combined with the support structure. This makes manufacture of a range of items of furniture simpler, and reduces manufacturing and storage costs.

Possible functional elements 18 within the scope of the present invention are for example decorative elements, sound-absorbent elements, boards for writing on, pin boards, magnetic boards, light elements and the like, and combinations thereof.

The functions and shapes of the functional element 18 of the door or wall element 14 are not restricted within the scope of this invention, in particular not in respect of their material and their intrinsic dimensional stability. Thus, almost unlimited variants on the component 14 which may be created on the basis of the inventive basic construction of the component are conceivable.

With reference to FIGS. 5 to 9, different variants on the basic structure (illustrated in FIG. 2) of the panel-shaped door or wall element 14 having different functional elements 18 will be described in detail by way of example, without there being any intention of restricting the present invention to these particular embodiments.

In the exemplary embodiment illustrated in FIG. 5, an intermediate layer 28 is arranged between the support sheet 16 and the functional element 18. The intermediate layer 28 may for example be a connecting layer (gripper-type connection, gluing, damping layer).

The second exemplary embodiment, in FIG. 6, shows a support sheet 16 that takes the form of a solid sheet, having four bent-around edges 17. The functional element 18 is formed by a lightweight chipboard or honeycomb panel 30 or the like, and an outer layer 32 of linoleum, cork or the like.

The third exemplary embodiment, illustrated in FIG. 7, differs from the second exemplary embodiment above in that the outer layer 34 is formed by an enameled steel.

For the outer layers 32, 34, materials such as wood, mesh, fabric, metal, lightweight metal, magnetic materials and so on are further conceivable. The inner layer 30 of the functional element 18 is similarly not restricted to the lightweight chipboard or honeycomb panel.

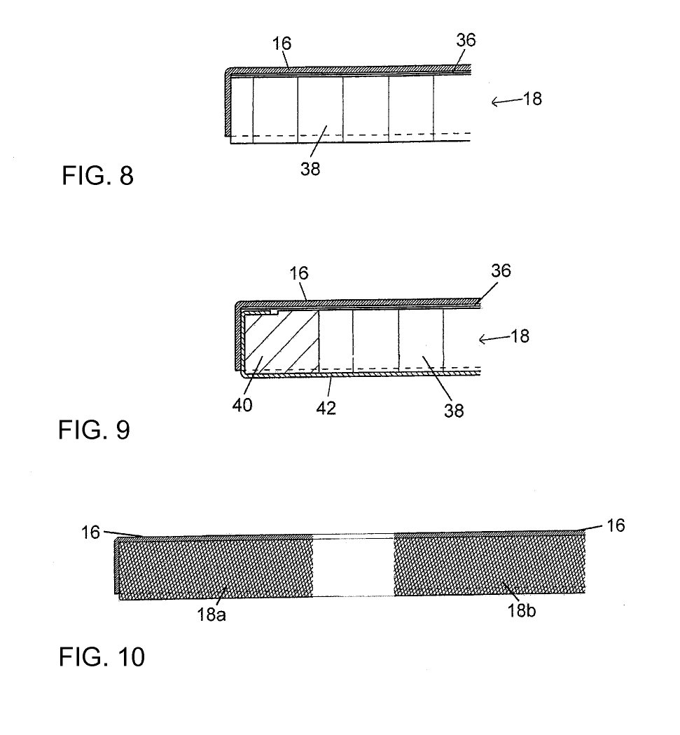

FIG. 8 shows, as a fourth exemplary embodiment, a door or wall element 14 having the functional element 18 that takes the form of a sound-absorbent element. Here, the support sheet 16 preferably takes the form of a perforated sheet that is coated on the inside with an acoustic fleece 36. Optionally, a solid sheet may also be used for the support sheet 16. The actual functional element 18 is constructed from an element 38 having acoustic properties, of any desired construction. For example, the sound-absorption panels that are mentioned in the introduction to the description of this application may be used for the element 38.

In a further development of the fourth exemplary embodiment, the component 14 illustrated in FIG. 9 has a functional element 18 that is formed by a material having sound-absorbent properties 38, that is held in a frame 40 of solid wood or the like, and that is provided on the outside with a sheath/cover 42 of fabric or the like. If the functional element 18 is a sound-absorbent element, as is the case in the examples of FIGS. 8 and 9 above, it is advantageous for the support sheet 16 to take the form of a perforated sheet such that the sound waves also penetrate into the interior of the item of furniture and can be absorbed there, that is to say that the volume of sound absorption is increased.

A support sheet 16 taking the form of a perforated sheet also has the advantage of lower weight. As a result of the bent-around edges 17 of the support sheet 16, however, sufficient dimensional stability of the support sheet 16 and the cabinet door 14 can be ensured even in the case of a perforated sheet.

In a further particular embodiment, which is not illustrated in the drawings, the component 14 is formed by a support sheet 16, which takes the form of a perforated sheet and which has arranged or glued on its side that faces the functional element 18 an acoustic fleece 36, and the functional element 18, in which case the functional element 18 also has an outer perforated sheet/micro-perforated sheet, which has arranged or glued on its side that faces the support sheet 16 an acoustic fleece. The cavity between the two perforated sheets that are coated with an acoustic fleece is optionally additionally filled with a material 38 having sound-absorption properties (e.g. mineral foam, fleece material, corrugated cardboard, etc.). With this structure of the component 14, the support sheet 16 simultaneously acts as part of the sound-absorbent element. Some of the sound waves penetrate through the perforated sheet of the functional element 18 into the component 14 and are then reflected back and forth between the two layers of acoustic fleece of the perforated sheets and hence absorbed; another portion of the sound waves penetrates further, through the perforated support sheet 16 into the interior of the item of furniture 10, and can similarly be absorbed in the volume thereof.

In a further variant, which is not illustrated in the drawings, electrical or electronic components may also be integrated into the functional element 18.

With reference to FIG. 10, a variant on the basic structure of the panel-shaped door or window element 14 in FIG. 2 will now be described.

Unlike the embodiment in FIG. 2, in this case two functional elements 18a, 18b are provided, and these are arranged next to one another and connected to the one support sheet 16. These two functional elements 18a, 18b may either be like or differing functional elements (that is to say with the same or different properties or tasks). For example, in the upper region of a cabinet door 14 a light element 18a may be provided, whereas the functional element 18b in the lower region takes the form of a sound-absorbent element. The possibilities for variation of the component 14 in this variant are even more numerous. It goes without saying that the door or wall element 14 may also have more than two functional elements 18a, 18b, and may be divided in any way.

1. A piece of furniture selected from the group consisting of a cabinet and shelving, the furniture comprising:
at least one structure selected from the group consisting of a panel-shaped door and a panel-shaped wall element and having an inner side and an outer side, said structure further having a stable support sheet disposed on said inner side, a functional element disposed on said outer side and connected to said support sheet, and a fitting mounted on said support sheet.

2. The piece of furniture according to claim 1, wherein said support sheet has at least one edge bent around in a direction of said functional element.

3. The piece of furniture according to claim 2, wherein all of said edges of said support sheet are bent around in the direction of said functional element.

4. The piece of furniture according to claim 1, wherein said fitting is secured to said support sheet.

5. The piece of furniture according to claim 1, wherein said fitting is integrated into said support sheet.

6. The piece of furniture according to claim 1, wherein said support sheet is a perforated sheet.

7. The piece of furniture according to claim 1, wherein said structure has an intermediate layer disposed between said support sheet and said functional element.

8. The piece of furniture according to claim 1, wherein said functional element is a one-piece functional element.

9. The piece of furniture according to claim 1, wherein said functional element has a plurality of one of similar functional elements and different functional elements.

10. The piece of furniture according to claim 1, wherein said functional element is selected from the group consisting of decorative elements, sound-absorbent elements, boards for writing on, pin boards, magnetic boards, light elements and combinations thereof.

11. The piece of furniture according to claim 1, wherein:
said support sheet is a perforated sheet;
said structure has a fleece disposed on a side thereof that faces said functional element; and
said functional element has a perforated sheet, said fleece disposed on a side thereof that faces said support sheet, and defines a cavity between said support sheet and said perforated sheet of said functional element.

12. The piece of furniture according to claim 11, further comprising a material having sound-absorption properties filling said cavity.
